(19) United States
(12) Patent Application Publication
(10) Pub. No.: US 2008/0066590 A1
(43) Pub. Date: Mar. 20, 2008

(54) TWISTING SPANNER WITH AUTO POSITIONING ASSEMBLY

(76) Inventor: Chih-Ching Hsieh, Taichung City (TW)

Correspondence Address: Chih-Ching Hsieh, 235 Chung - Ho Box 8-24, Taipei, 235, TW

(21) Appl. No.: 11/944,470

(22) Filed: Nov. 23, 2007

Related U.S. Application Data
(62) Division of application No. 11/455,803, filed on Jun. 20, 2006.

(51) Int. Cl. B25B 23/159

(52) U.S. Cl. 81/483

(57) ABSTRACT

A twisting spanner with an auto positioning assembly comprises a push post; a sound seat; and a periphery of the supporting seat having a buffer cover; and a spring; one end of the spring having a supporting seat; and at least one end of the supporting seat having a positioning body. The positioning body is integrally formed with the supporting seat. The positioning body is a ball. The supporting seat has a positioning hole facing to the positioning groove. The buffer cover is made of soft material. The buffer cover is made of copper. The supporting seat has a limiting post capable of being inserted into the spring. The supporting seat has a receiving hole receiving with at least one roller.

The present invention is a division application of U.S. patent Ser. No. 11/455,803, which is assigned to and invented by the inventor of the present invention, and thus the contents of the U.S. patent Ser. No. 11/455,803 is incorporated into the present invention as a part of the present invention.

The present invention related to the species about the claim 9 and 10 in the U.S. patent Ser. No. 11/455,803.

### FIELD OF THE INVENTION

The present invention relates to spanners, and in particular to a twisting spanner with an auto positioning assembly which can reduce the structure destroy of the wall of the buffer cover and the supporting seat thereof will be smooth and stable.

### BACKGROUND OF THE INVENTION

Referring to FIGS. 7 and 8, the prior art twisting spanner is illustrated. In operation, the handle 30 must be twisted and the step of twisting setting value is set according to a scale 31 and a spring 33 between a push post 32 and a supporting seat 20 is compressed. After setting, the handle 30 is fixed. In operation, a pin 44 at one end of a main arm 41 is twisted to press the roller 21 of the supporting seat 20. Likewise, the roller 21 provides a react force until the force from the spanner is over the twisting force. The roller 21 will release from the pin 44 and the main arm 41 returns rapidly. Thus an end 41 of the main arm 41 will knock the wall of the buffer cover 42 so as to have a knocking sound to inform the user not to increase the applied force for preventing the spanner from destroy

However since the prior art spring 33 is long, as shown in FIG. 8, to cause the wall of the supporting seat 20 is smooth and the spring 33 can be compressed easily, the inner diameter is greater, but as a result, the spring 33 will bent. As a result the twisting value is not accuracy and is not stable. Thereby the spring 33 will fatigue and not return to the original position. That is to say that the moving length of the push post 32 driving by the handle 30 is long so that the twisting force cannot be set accuracy. It has an error of about 4%. The longer the spring, the greater the error. Furthermore, in the prior art, the supporting seat 20 has a hard ball to contact the wall of the buffer cover 42 so that the wall of the buffer cover 42 will be destroyed.

Moreover one end of the supporting seat 20 has a ball 23 ejecting the wall of the buffer cove 42 so that the supporting seat 20 will tilt so that the supporting seat 20 will be buckled. As a result the twisting value is not accurate.

### SUMMARY OF THE INVENTION

Accordingly, the primary object of the present invention is to provide a twisting spanner with an auto positioning assembly which can reduce the structure destroy of the wall of the buffer cover and the supporting seat thereof will be smooth and stable.

To achieve above objects, the present invention provides a twisting spanner with an auto positioning assembly which comprises a push post; a sound seat; and a periphery of the supporting seat having a buffer cover; and a spring; one end of the spring having a supporting seat; and at least one end of the supporting seat having a positioning body. The positioning body is integrally formed with the supporting seat. The positioning body is a ball. The supporting seat has a positioning hole facing to the positioning groove. The buffer cover is made of soft material. The buffer cover is made of copper. The supporting seat has a limiting post capable of being inserted into the spring. The supporting seat has a receiving hole receiving with at least one roller.

The various objects and advantages of the present invention will be more readily understood from the following detailed description when read in conjunction with the appended drawing.

### BRIEF DESCRIPTION OF THE DRAWINGS

FIG. 1 is an assembled view of the present invention.

FIG. 2 is an exploded view of the present invention.

FIG. 3 is a cross sectional view of the present invention.

FIG. 4 is a partial enlarged view of the present invention.

FIG. 5 is a schematic view about the spring of the present invention.

FIG. 6 is a schematic view showing that the spring is compressed according to the present invention.

FIG. 7 is a cross sectional view of the prior art twisting spanner.

FIG. 8 is a schematic view showing that the spring is compressed according to the prior art.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

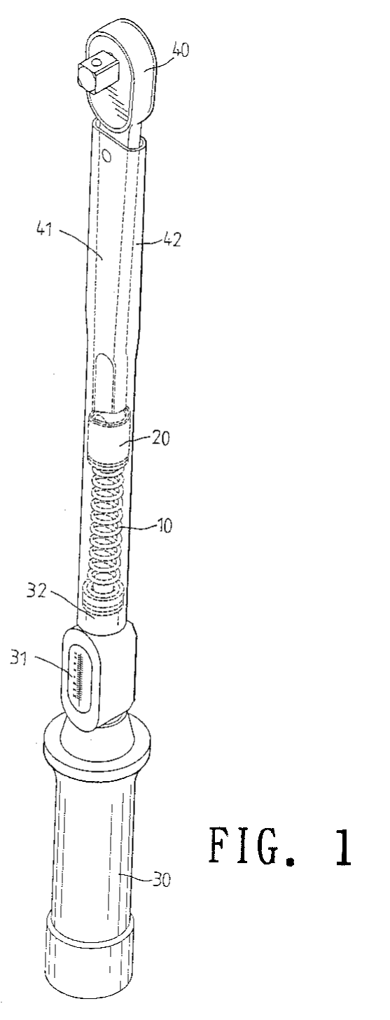

With reference to FIG. 1 to 4, the structure of the present invention is illustrated. The present invention has the following elements.

A spring 10 has two ends. One end of the spring 10 has a supporting seat 11. One end of the supporting seat 11 has a limiting post 12. The limiting post 12 can be inserted into the spring 10. Another end of the supporting seat 11 has a positioning body 13. The supporting seat 11 and the positioning body 13 can be formed integrally or separately.

A sound seat 20 is installed at another end of the spring 10. A roller 21 is installed within the sound seat 20 by using a shaft 211 to pass through the sound seat 20 and the roller 21. The sound seat 20 has two receiving holes 22 near the roller 21. Each receiving hole 22 is received with a ball 23. Thereby the roller 21 can roll easily.

A buffer cover 24 sleeves the sound seat 20. The sound seat 20 is made of soft material, for example, copper. A lower side of the buffer cover 24 has a positioning groove 241. A periphery of the buffer cover 24 has a round shape. Thus, the sound seat 20 can slide in the buffer cover 24 smoothly without tilt.

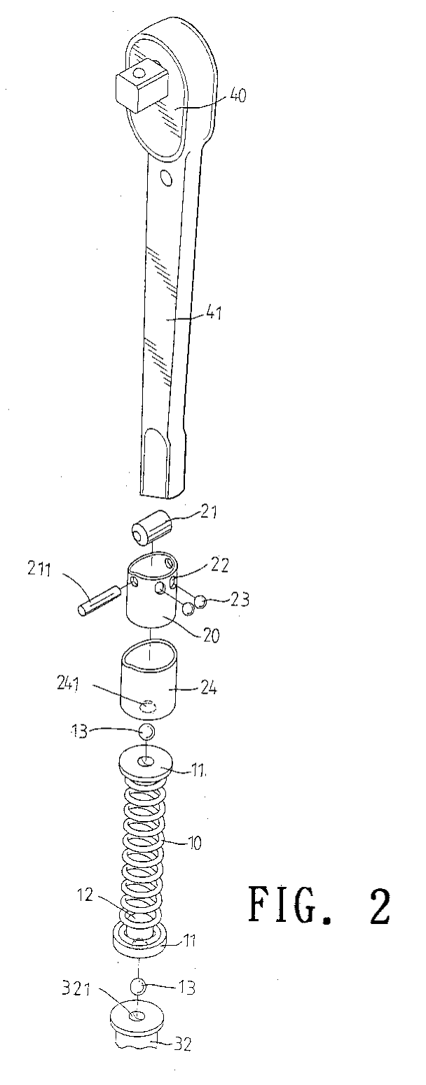

Referring to FIGS. 1 and 2, a pushing post 32 is located below the spring 10. A scale 31 is located below the pushing post 32 and an adjustable handle 30 is rotatably located below the scale 31. The setting of the twisting force applied from the spanner can be set with reference to the scale 31. An upper center of the pushing post 32 has a positioning hole 321 for receiving the positioning body 13.

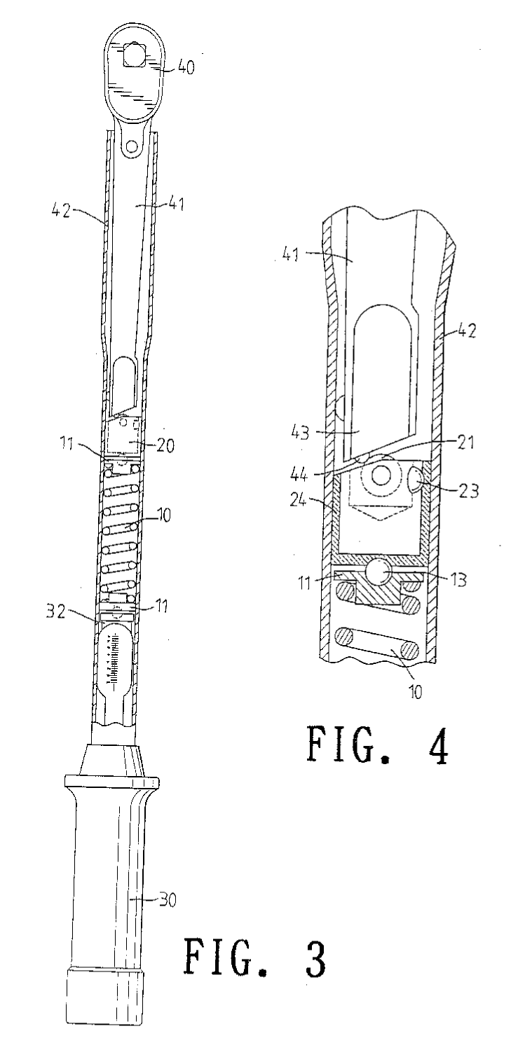

Referring to FIGS. 3 and 4, a main arm 41 extends from a driving portion 40. A sleeve 42 sleeves the main arm 41, sound seat 20, spring 10 and push post 32. One end portion 43 of the main arm 41 is extended with a pin 44.

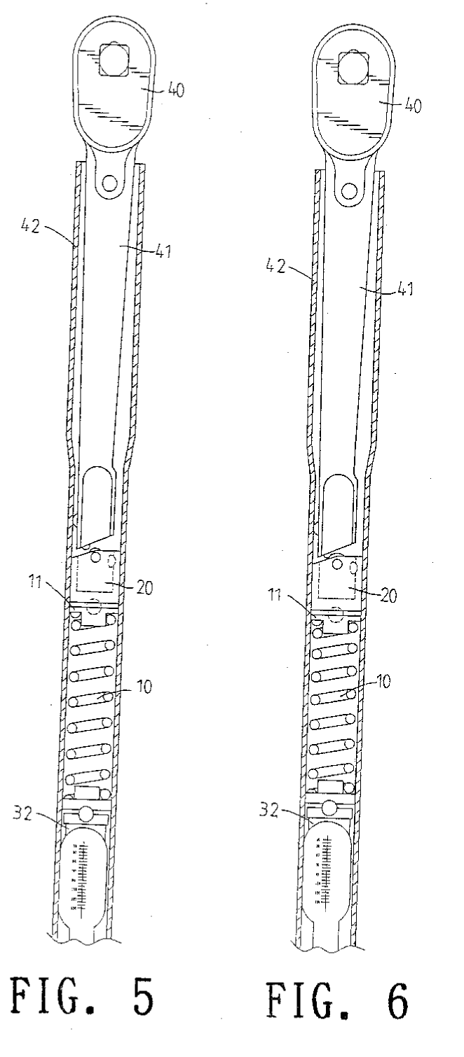

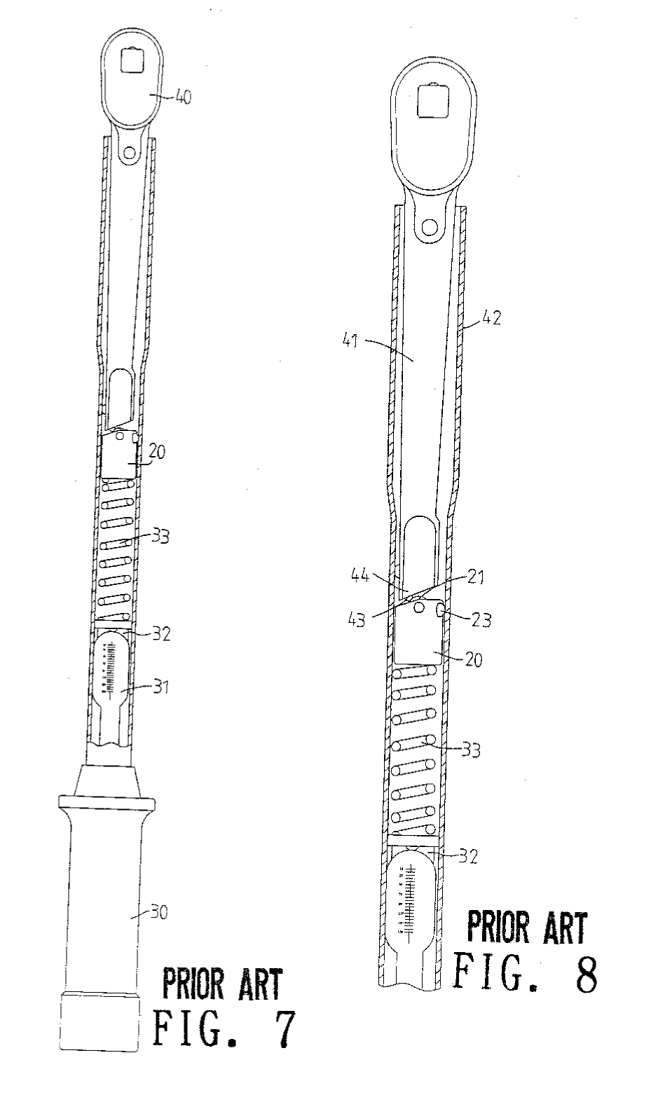

Referring to FIGS. 5 and 6, in assembly, the supporting seat 11 is located in the positioning groove 241 of the buffer cover 24 and the positioning body 13 is received in the positioning hole 321 of the push post 32 so that the spring 10 can be retained in a straight state. When the push post 32 of the adjustable handle 30 presses the spring 10, the spring 10 still retains straightly. Thus the length of the spring 10 can be well controlled so that the twisting force for separating the roller 21 and the pin 44 at the end of the main arm 41 can be well adjusted. Thus the middle section of the spring 10 will not bent. Thereby the spring 10 will not fatigue.

Moreover in the present invention, the positioning body 13 can be a ball so that the positioning body 13 is rollable in the positioning hole 321 of the push post 32. Thus the spring 10 can resilient rapidly so that the sensitivity about the setting of the twisting force is enhanced with higher precision and accuracy. The buffer cover 24 has the effect of protecting the sound seat 20.

Advantages of the present invention will be described herein. In the present invention, by the supporting seat and the positioning body, the spring can be steadily located in the buffer cover so that the length of the spring can be well controlled with higher precision and accuracy. The positioning body can be a ball so that the spring can resilient rapidly so that the sensitivity about the setting of the twisting force is enhanced with higher precision and accuracy. Furthermore, the buffer cover has the effect of protecting the sound seat. Further the buffer cover is made of copper which can dissipate heat effectively. As the buffer cover is used for a long time, it can retained in a preferred smoothness.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A supporting seat of a twisting spanner comprising at least one receiving hole; at least one roller being installed into the receiving hole and a periphery of the supporting seat having a buffer cover.

2. The supporting seat as claimed in claim 1, wherein the buffer cover is made of copper.
